(19) United States
(12) Patent Application Publication
(10) Pub. No.: US 2007/0160718 A1
(43) Pub. Date: Jul. 12, 2007

(54) Method for preparing food by coextrusion, in particular sausage and food products obtained by this method

(75) Inventor: Peter R. Visser, Nijmegen (NL)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RED ARROW PRODUCTS COMPANY LLC, Manitowoc, WI (US)

(21) Appl. No.: 11/181,563

(22) Filed: Jul. 13, 2005

(51) Int. Cl. A22C 13/00

(52) U.S. Cl. 426/135; 426/516

(57) ABSTRACT

A coextrusion method for preparing an encased foodstuff is disclosed. The encased foodstuff has a casing containing a fibrous protein and a polysaccharide. The casing is coextruded over a filling material, such as a meat product, to provide the encased foodstuff.

The invention under consideration relates to a method for the manufacture of foodstuff products using coextrusion.

Coextrusion is known from GB-A-1 232 801. In this document, coextrusion is described as a process that is performed using a casing material that is composed of collagen, being a fibrous protein that hardens into a usable (edible?) sausage skin after coextrusion.

The advantages of coextrusion in modern sausage manufacture, such as speed and product uniformity, are obvious. However, the use of a collagen-containing material produces a sausage skin with characteristics that are not suitable for every type of sausage.

In this context we refer to GB-A-1 040 770 which documents the use of a collagen in combination with an alginate for the manufacture of casings for sausage products. However, coextrusion is not used in that particular process.

The invention specifically relates to a method for producing foodstuff products from meat and a casing material that is in liquid form prior to the coextrusion process, whereby the casing material contains at least one fibrous protein and one polysaccharide.

A similar method has been documented in NL-A-1016018.

This document describes the sausage manufacturing process using coextrusion, whereby the casing material contains between 0.5% and 2.5% collagen, between 1.5% and 2.5% collagen, or more than 1.5% collagen. Sausage products with casings of such a composition are initially strong enough, but the casing's strength decreases after a few days which could result in damage to the sausage.

The purpose of the invention is to provide a method for the production of a type of sausage, in which the strength of the skin is maintained for a longer period of time.

This goal can be achieved by using a process in which the casing material contains a greater weight fraction of fibrous protein than of polysaccharide.

This composition produces a sausage skin the strength of which is maintained over a longer period of time. It is assumed that the better shelf-life of the skin is attributable to the higher content of fibrous protein in the mixture since the gel that is formed by the polysaccharide will relatively quickly absorb water and thus lose its strength. This effect is counteracted by the higher content of the more stable fibrous protein.

In this context it should be mentioned that, in addition to water, the casing material when prepared according to NL-A-101018 also contains gums that will make some contribution to the strength of casings made from the casing material. In the invention under consideration, the addition of such gums or other strengthening agents is not necessary.

(22) These advantages can also be observed in any foodstuff product obtained by coextrusion that consists of a filling material and a casing material, where the casing contains at least one fibrous protein and a polysaccharide, and where the casing contains a greater weight fraction of fibrous protein than of polysaccharide.

(2) It is preferable when the weight fraction of the fibrous protein in the casing material is 1.2 times greater than that of polysaccharide. It is more preferable when it is 1.5 times greater, even more preferable when it is more than 2 times greater, and most preferable if the weight fraction of fibrous protein in the casing material is more than 2.5 times greater than that of polysaccharide. Tests have shown that optimal results are obtained when casing materials have compositions above these weight ratios.

(23) These favorable results are also observed in foodstuff products obtained by coextrusion with skins made from casing material for which the weight fraction of the fibrous protein is more than 1.2 times, preferably more than 1.5 times, more preferably more than 2 times, and most preferably more than 2 times (sic) greater than the weight fraction of the polysaccharide.

(3) The inventors have found that the strength of the skin of a foodstuff, specifically during a period of up to approximately 14 days after coextrusion, is optimal when the casing material that is used for the method according to the invention has a fibrous protein content ranging between 2% and 7% by weight, preferably between 3% and 6% by weight, and most preferably between 3.5% and 5.5% by weight.

(4) A further optimization of the skin's characteristics is obtained when the casing material contains between 1% and 5% by weight of polysaccharides, preferably between 2% and 4% by weight of polysaccharides.

(5) According to an additional embodiment, the fibrous protein is formed from a collagen. Although other types of fibrous proteins are not excluded, tests with collagens have shown that collagen produces excellent results. In addition, collagen has the advantage that it is easily available and that it is an acceptable product in this branch of the industry.

(24) These advantages are also obtained for foodstuff products obtained by coextrusion for which the fibrous protein consists of collagen.

(6) Yet another embodiment states that the polysaccharide be formed from an alginate. This material is also commonly used in the food industry and, in practice, yields optimal results. However, other polysaccharides are not excluded.

(25) These advantages are also noted for foodstuff products obtained through coextrusion when the polysaccharide is formed from an alginate.

Alginates occur bound to various metal ions; thus sodium alginate, potassium alginate, or calcium alginate can be utilized.

(7) The invention is applicable to numerous types of foodstuff products such as vegetarian sausage, but currently it is anticipated that the invention will have its widest application in the manufacture of sausage and sausage-related products. (i.e., meat-based sausage.—Translator.)

(26) Thus, the invention refers in essence to a sausage obtained by coextrusion.

(8) Preferably, extrusion of the casing for the foodstuff product is carried out with an extrusion head that forces the casing material to slide in a direction that transverse to the extrusion direction.

With the use of an extrusion head, the casing material (while it is still in its plastic state) will be subjected to shearing forces during the coextrusion process. These shearing forces work not only in the direction of the extrusion process, but also transversely to the extrusion process. As a result, the fibers or molecules of the fibrous protein will be forced into mutually opposite directions which increases the number of crossing fibers or molecules, which in turn greatly increases the skin's strength and durability.

(9) Preferably, extrusion of the casing for a foodstuff product is carried out with the aid of an extrusion head that contains at least one part consisting of a moving component that rotates at an angle to the extrusion direction and comes into contact with the casing product. This design calls for a relatively simple construction for an extrusion head which will enable the casing material to be additionally subjected to shearing forces in a direction that is transverse to the extrusion direction.

(10) The shearing forces can be further increased when extrusion of the casing for the foodstuff product is carried out with the aid of an extrusion head that contains two extrusion heads rotating in mutually opposite directions that both come in contact with the casing material.

(11) As is usually customary in coextrusion processes, for the method according to the invention too, the coextruded product is immersed in or sprayed with a solution that enhances the strength of the skin. Preferably, the foodstuff product is brought in contact with a salt solution after extrusion. Namely, the salt solution influences the dewatering of the polysaccharides in the coextruded product skin.

(12) Preferably, a salt solution in the form of a calcium salt is utilized because this salt is very useful for foodstuff products and has a low cost price.

(13) Specifically, CaCl₂ is used as salt for this purpose.

(14) The inventors have found that this effect is optimal for foodstuff products that have been prepared according to the method described above when the salt concentration in the solution ranges between 2% and 20%.

(15, 16) Furthermore, it has become evident that in order to obtain optimum results, the temperature of the solution should preferably range between 0° C. and 40° C. and the time that the sausage is in contact with the solution should preferably range between 2 and 40 seconds.

It should be pointed out here that it is actually possible to use the fibrous protein by itself, i.e., without the addition of polysaccharide, but this would require the use of an expensive cross-linking agent or a strong water-extracting salt. Both possibilities lead to a high cost and to discoloration of the sausage, which is also not always preferable. The use of CaCl₂ under the above-mentioned circumstances avoids these drawbacks.

(17, 18) There are several possibilities for exposing the foodstuff product to the solution; it is possible to spray the foodstuff product with the solution, but it is also possible to immerse the foodstuff product into the solution.

(19, 27) Although other types of sausage, such as smoked sausage or cooked sausage are not excluded, the advantages of the invention are specifically evident when the method is used for the production of fresh sausage. In this context, fresh sausage is defined as any sausage that has not been subjected to any heat treatment prior to sale. After production, fresh sausage is generally cooled and sold to the consumer after cooling. Examples of fresh sausage are sausage rolls made of fresh sausage in the more narrow definition of the word, and so-called chipolata sausage. Other sausage types that are not subjected to heat treatment before being sold are in no way excluded.

In this context it should be pointed out here that other types of sausage usually are subjected to some type of processing such as smoking or cooking, which generally has a beneficial effect on the strength and shelf-life of the sausage skin. This is not the case for fresh sausage, thus it is of the greatest importance that a skin of this type of sausage not only possess initially enough strength, but also that this strength be maintained for the shelf-life of the sausage. In view of the fact that fresh sausage does not undergo any preservative processing, the usual maximal shelf-life of this type of sausage ranges between 10 and 14 days.

(20) In order to prevent the rapid spoilage of fresh sausage, fresh sausages are preferably subjected to a cooling process after the sausages had been sized to their proper lengths.

(21) For this cooling process, sausage should preferably be cooled to a temperature of 6°-7° C.

1-27. (canceled)

28. A casing material for a foodstuff comprising a fibrous protein, a polysaccharide, and water, wherein the casing material contains a weight fraction of the fibrous protein that is more than 1.2 times greater than the weight fraction of the poly-saccharide.

29. The casing material of claim 28 wherein the weight fraction of the fibrous protein is more than 1.5 times greater than the weight fraction of the polysaccharide.

30. The casing material of claim 28 wherein the weight fraction of the fibrous protein is more than 2 times greater than the weight fraction of the polysaccharide.

31. The casing material of claim 28 wherein the weight fraction of the fibrous protein is more than 2.5 times greater than the weight fraction of the polysaccharide.

32. The casing material of claim 28 comprising 2% to 7%, by weight, of the fibrous protein.

33. The casing material of claim 28 comprising 3% to 6%, by weight, of the fibrous protein.

34. The casing material of claim 28 comprising 3.5% to 5.5%, by weight, of the fibrous protein.

35. The casing material of claim 28 comprising 1% to 5%, by weight, of the polysaccharide.

36. The casing material of claim 28 comprising 2% to 4%, by weight, of the polysaccharide.

37. The casing material of claim 28 wherein the fibrous protein comprises collagen.

38. The casing material of claim 28 wherein the polysaccharide comprises an alginate.

39. The casing material of claim 28 wherein the material is in the form of a paste.

40. The casing material of claim 28 further comprising a salt in an amount of about 2% to about 20% by weight.

41. The casing material of claim 40 wherein the salt is a calcium salt.

42. The casing material of claim 41 wherein the calcium salt comprises calcium chloride.

43. A foodstuff comprising a meat product and a casing wherein the casing comprises a casing material of claim 1.
